(19) United States
(12) Patent Application Publication
(10) Pub. No.: US 2024/0398167 A1
(43) Pub. Date: Dec. 5, 2024

(54) FOOD PROCESSING DEVICE

(71) Applicant: HCL Technologies Limited, New Delhi (IN)

(72) Inventors: Yuvaraj D Patil, Bengaluru (IN); Vishwanath Vazar, Bengaluru (IN); Rathish Kumar, Bengaluru (IN)

(21) Appl. No.: 18/657,939

(22) Filed: May 8, 2024

(30) Foreign Application Priority Data
Jun. 1, 2023 (IN) 202311037828

(51) Int. Cl. A47J 42/36; A47J 42/34; A47J 42/46; A47J 42/50

(52) U.S. Cl. CPC A47J 42/36; A47J 42/34; A47J 42/46; A47J 42/50

(57) ABSTRACT

A food processing device is disclosed that includes a rotation source generating a rotatory motion about a first axis of rotation (A1) and an auger mechanically coupled to the rotation source. The rotation source imparts rotatory motion to the auger, such that the first axis of rotation (A1) of the rotation source is offset from a second axis of rotation (A2) of the auger. The auger is configured to receive a food-product. A cutter assembly is positioned vertically below the auger that receives the food-product from the auger. The cutter assembly includes a stator cutter and a rotating cutter configured to rotate relative to the stator cutter. The auger is mechanically coupled to the rotating cutter to cause the rotating cutter to rotate.

### TECHNICAL FIELD

This disclosure relates generally to a food processing device, and in particular to a system and apparatus for processing coffee beans and similar food products.

### BACKGROUND

Food processing devices, such as coffee bean grinders, are available in different sizes and capacity. The coffee bean grinders include a cutter assembly which is adapted to cut (i.e. grind) the coffee beans into fine powder. As the coffee beans are grinded by the cutter assembly, the powder (i.e. the grounded coffee beans) is accumulated within the cutter assembly itself. This leads to coagulation, which blocks grinding of the subsequent supply of the coffee beans. As a result, the yield of the powder from the coffee bean grinder is reduced. Moreover, it is a challenge of cleaning the cutter assembly, especially after the accumulation of the grinded coffee beans therewithin.

Therefore, a food processing device is desired which can effectively restrict the accumulation of the powder in the cutter assembly, allows all of the grinded coffee beans to be flushed, thereby eliminating or reducing the need for cleaning of the apparatus.

### SUMMARY

In an embodiment, a food processing device is disclosed. The food processing device may include a rotation source generating a rotatory motion about a first axis of rotation and an auger mechanically coupled to the rotation source. The rotation source may be configured to impart rotatory motion to the auger. The first axis of rotation of the rotation source may be offset from a second axis of rotation of the auger. The auger may be configured to receive a food-product from a top passage and transfer the food-product towards a bottom passage. The food processing device may further include a cutter assembly positioned vertically below the auger. The cutter assembly may be configured to receive the food-product from the auger via the bottom passage. The cutter assembly may include a stator cutter and a rotating cutter configured to rotate relative to the stator cutter. The auger may be mechanically coupled to the rotating cutter via a coupler to cause the rotating cutter to rotate about the second axis of rotation, to grind the food product.

In an embodiment, a food-product grinding assembly is disclosed. The food-product grinding assembly includes an auger configured to mechanically couple to a rotation source of a food processing device. The rotation source may be configured to generate a rotatory motion about a first axis of rotation. Upon coupling, the auger may be configured to be rotated by the rotation source. The first axis of rotation of the rotation source may be offset from a second axis of rotation of the auger. The auger may be configured to receive a food-product from a top passage and transfer the food-product towards a bottom passage. The food-product grinding assembly may further include a cutter assembly positioned vertically below the auger. The cutter assembly may be configured to receive the food-product from the auger via the bottom passage. The cutter assembly may include a stator cutter and a rotating cutter configured to rotate relative to the stator cutter. The auger may be mechanically coupled to the rotating cutter via a coupler to cause the rotating cutter to rotate about the second axis of rotation, to grind the food product.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a schematic front view of an exemplary food processing device, in accordance with some embodiments of the present disclosure.

FIG. 2 illustrates an exploded view of the exemplary food processing device, in accordance with some embodiments.

FIG. 3 illustrates a schematic sectional front view of the food processing device, in accordance with some embodiments.

FIG. 4 illustrates an exploded view of a food-product grinding assembly, in accordance with some embodiments.

FIG. 5 illustrates a magnified view of an auger, in accordance with some embodiments.

FIG. 6 illustrates a top view of the auger, in accordance with some embodiments.

FIG. 7 illustrates a sectional side view of the auger, in accordance with some embodiments.

FIG. 8 illustrates an exploded view of an adjustment assembly of the food processing device, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

A food processing device, and in particular, a system for grinding coffee beans is disclosed in this disclosure. The food processing device includes a cutter assembly, a feeder assembly, a hopper, and a lid. The cutter assembly is equipped with a stator cutter and a rotating cutter. The stator cutter and the rotating cutter can be of any design, for example conical or a flat disc or blade type. The rotating cutter is attached to the feeder assembly which has an internal motor which drives an auger. The motor may drive the auger through a set of reduction gears or using a belt drive or a bevel gear or via a direct mechanical coupling. The motor and the auger may be integral part of the feeder assembly. The augur shares its axis of rotation with the rotating cutter and this axis is offset from the axis of the motor. As such, the motor is not positioned vertically above the cutter assembly.

The auger is configured to push the food product (e.g. coffee beans) to be processed from the hopper to the cutter assembly, thereby maintaining the flow of the food product and preventing the blockage of the cutter assembly with the processed food product. The rotating cutter rotates relative to the stator cutter, thereby grinding the food product between the blades of the rotating cutter and the stator cutter. An adjustment assembly is provided which includes an adjustment ring and an adjustment sleeve. The cutter assembly is positioned in a central hole of the adjustment ring. The adjustment ring can be manipulated manually for causing movement of the stator cutter vertically along its axis of rotation, to thereby change the configuration of the cutter assembly. This vertical movement of the stator cutter further allows for removal of the coffee powder from the cutter assembly.

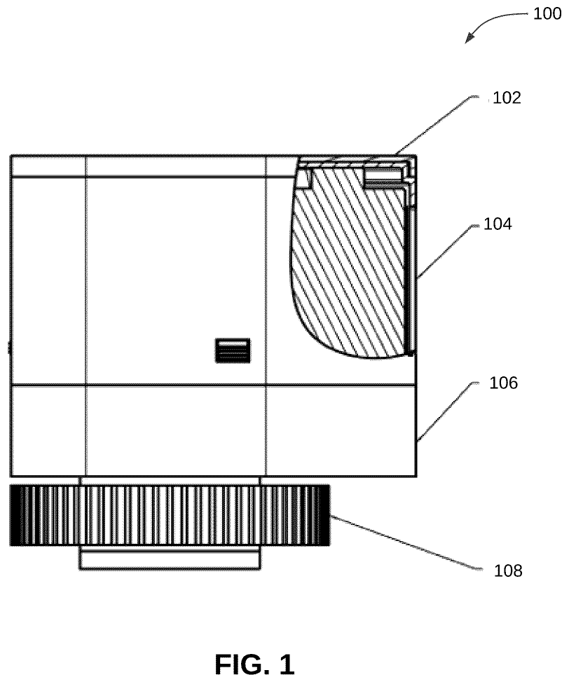

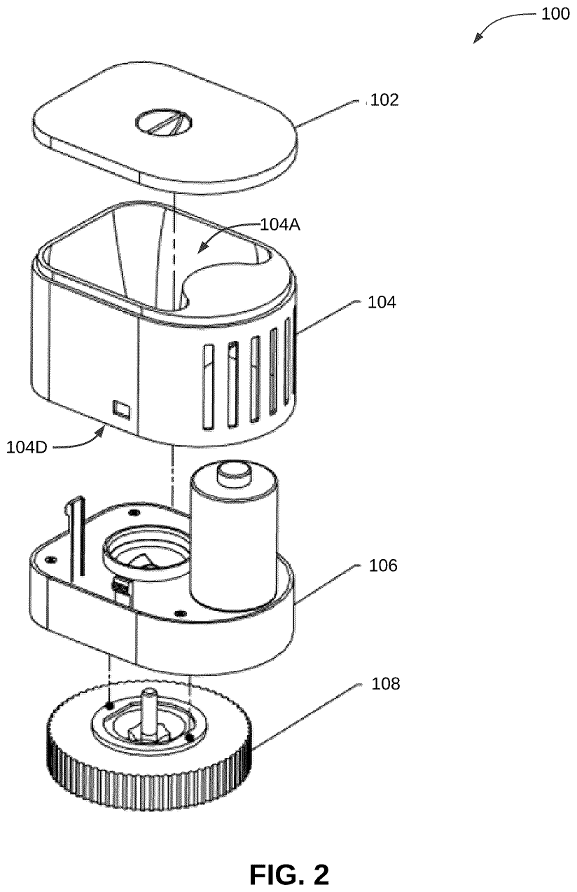

Referring now to FIGS. 1-2, a schematic front view and an exploded view, respectively of an exemplary food processing device 100 is illustrated, in accordance with some embodiments of the present disclosure. The food processing device 100, in particularly, may be configured for grinding coffee beans for preparing a coffee-based beverage. However, the utility of the food processing device 100 may not be limited to grinding coffee beans and may extend to other food processing applications as well.

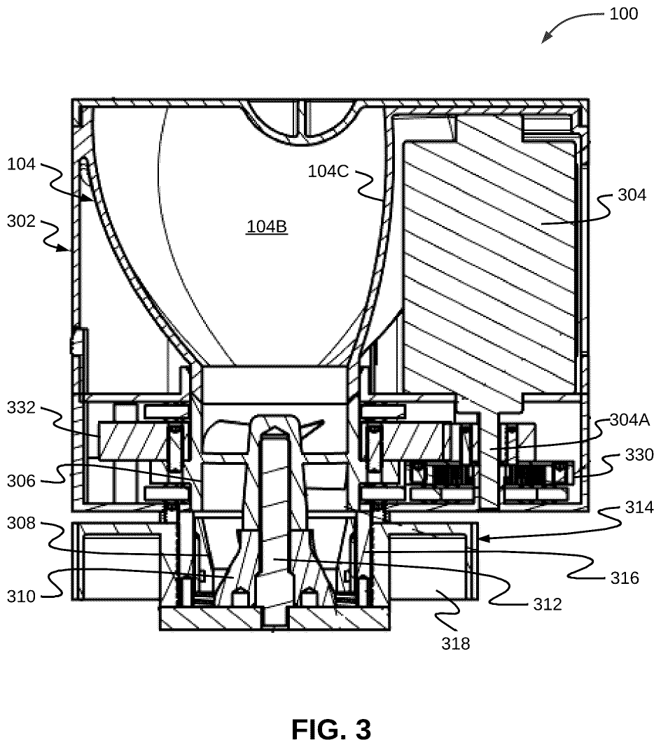

The food processing device 100 may include a lid 102, a hopper 104, a feeding system 106, and a cutter assembly 108. As shown in FIGS. 1-2, in some embodiments, the hopper 104 may be configured to couple with the feeding system 106, and the feeding system 106 may be configured to couple with the cutter assembly 108. The food product to be processed may be fed into the hopper 104 by opening the lid 102. The hopper 104 may be configured to store the food-product to be grinded. Further, the hopper 104 may be configured to supply the food-product to the feeding system 106. The feeding system 106 may include an auger (refer, FIG. 3-5) which may be driven by a rotation source. The rotation source may drive the auger through a set of reduction gears or using a belt drive or a bevel gear or via a direct mechanical coupling, to enable the auger to push the food product (e.g. coffee beans) from the hopper to the cutter assembly 108.

The lid 102 may be positioned at the top of the hopper 104 to cover a top opening 104A (as shown in FIG. 2) associated with the hopper 104. The hopper 104 and the lid 102 may be made from a rigid material, such as a plastic, a metal, or an alloy. The food product fed into the hopper 104 may transfer to the feeding system 106. From the feeding system 106, the food product may be transferred to the cutter assembly 108. The cutter assembly 108 may be configured to receive the food-product from the feeding system 106 via a bottom passage associated with the feeding system 106 (i.e. the auger). The cutter assembly 108, upon receiving the food product, may process (for example, grind) the food product. The food processing device 100 may further include an adjustment assembly configured to operate the cutter assembly 108 to vertically move a stator cutter relative to a rotating cutter of the cutter assembly 108, to thereby change the configuration of the cutter assembly 108. This vertical movement of the stator cutter allows for removal of the coffee powder from the cutter assembly 108. The food processing device 100 is further explained in detail in conjunction with FIGS. 3-8.

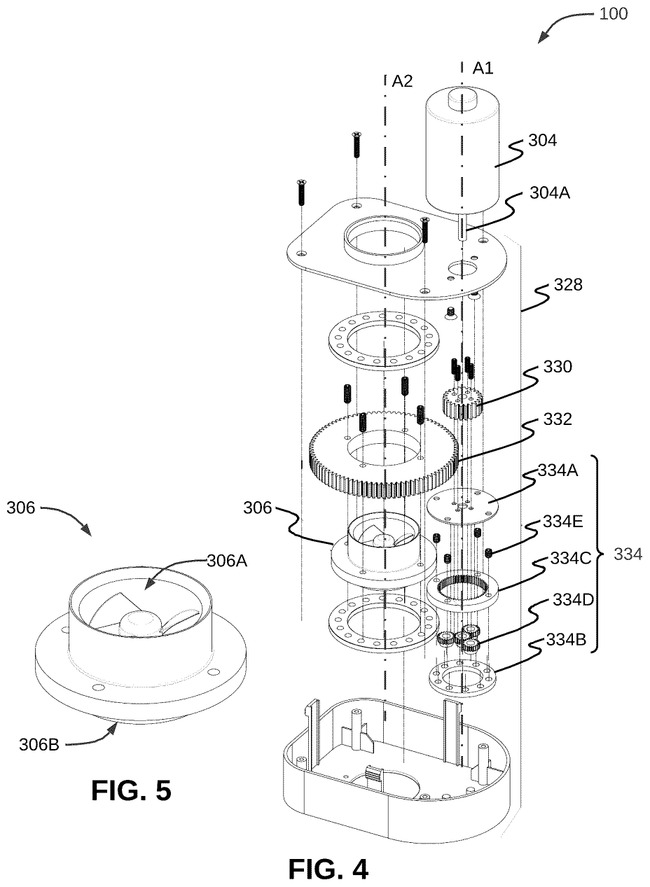

Referring now to FIGS. 3-4, FIG. 3 illustrates a schematic sectional front view of the food processing device 100, and FIG. 4 illustrates an exploded view of a food-product grinding assembly 400, in accordance with some embodiments. The food processing device 100, as shown in FIG. 3, may include a housing 302 which may be configured to house various other components of the food processing device 100. In some embodiments, the housing 302 may define the hopper 104. The housing 302 and therefore the hopper 104, for example, may be made from a rigid material, such as a plastic, a metal, an alloy, etc. As mentioned above, hopper 104 may be configured to store the food-product to be grinded and supply the food-product to an auger 306, via a bottom opening 104D of the hopper 104 and a top passage 306A of the auger 306. The bottom opening 104D of the hopper 104 may be configured to fit into the top passage 306A of the auger 306. The hopper 104 may be mounted on the top of the feeder system 106 (i.e. the auger 306). The hopper may include a bottom opening 104D which may sit onto the top of auger 306. This arrangement enables food product (e.g. coffee beans) to move down and enter the auger 306.

The food processing device 100 may further include a rotation source 304 configured to generate a rotatory motion about a first axis of rotation A1. The rotation source 304 may be fitted and secured within the housing 302 adjacent the hopper 104. The hopper 104 may be shaped in such a way that it covers the electric motor 304 (terms “rotation source” and “electric motor” may have been used interchangeable in this disclosure). For example, the rotation source 304 may be an electric motor, such as a direct current (DC) motor. In other example embodiments, the electric motor may be stepper motor, or any other type of electric motor as well. The rotation source 304, i.e. the electric motor, may generate a rotation via a first shaft 304A which may be oriented vertically along the first axis of rotation A1. It should be noted that in some alternative embodiments, the rotation source 304 may be a handle (not shown in FIGS. 3-6) which may be configured to be operated manually.

As shown in FIG. 3, the hopper 104 may be positioned adjacent to the rotation source 304. Further, the hopper 104 may define a storage area 104B and a wall 104C. The storage area 104B of the hopper 104 may be separated from the rotation source 304 by the wall 104C of the hopper 104. As such, the hopper 104 is shaped so as to accommodate the electric motor 304 (rotation source). Further, the electric motor 304 is isolated from the hopper 104 via the wall 104C of the hopper 104.

The food processing device 100 may further include the auger 306 mechanically coupled to the rotation source 304, i.e. to the first shaft 304A of the rotation source 304. The rotation source 304 may be configured to impart rotatory motion to the auger 306. The auger 306 may be configured to rotate about a second axis of rotation A2. It should be noted that the first axis of rotation A1 of the rotation source 304 may be offset from the second axis of rotation A2 of the auger 306. The auger 306 may include a top passage and a bottom passage. The auger 306 may receive a food-product from the top passage and then transfer the food-product towards the bottom passage 306B from where the food-product may be passed to the cutter assembly 108. The auger 306 is further explained in conjunction with FIGS. 5-7.

Referring now to FIGS. 5-7, a magnified view, a top view, and a sectional side view, respectively, of the auger 306 are illustrated in accordance with some embodiments. As shown in FIGS. 5-7, the auger 306 may be a cylindrical-shaped structure. The auger 306 may include a central hub 602 and a plurality of blades 604 that may be attached to the central hub 602. The central hub 602 and the plurality of blades 604 may be configured to rotate upon being driven by the rotation source 304.

As mentioned above, the auger 306 may receive the food-product from a top passage 306A of the auger 306. As a result of the rotation, the plurality of blades 604 may push the food-product towards a bottom passage 306B of the auger 306. From the bottom passage 306B, the food-product may be passed to the cutter assembly 108.

Referring again to FIGS. 3-4, as mentioned above, the food processing device 100 may further include the cutter assembly 108 that may be positioned within the housing 302 and vertically below the auger 306. The cutter assembly 108 may be configured to receive the food-product from the auger 306 via the bottom passage of the auger 306. In other words, the food-product, upon exiting the auger 306 via the bottom passage, may be transferred to the cutter assembly 108. The cutter assembly 108 may be configured to perform a cutting or grinding operation on the food-product received from the auger 306. In order to perform the cutting or grinding operation, the cutter assembly 108 may include a stator cutter 308 and a rotating cutter 310. The stator cutter 308 may be stationary and the rotating cutter 310 may rotate relative to the stator cutter 308. Both the stator cutter 308 and the rotating cutter 310 may include a set of blades for cutting the food product as the food product passes through the cutter assembly 108. As such, the auger 306, when it rotates, may push down the coffee beans between the rotating cutter 310 and the stator cutter 308, thereby providing a straight path for the coffee beans to be crushed/powdered. The crushed/powdered coffee beans may be exited via a nozzle. The auger 306 may be configured to transfer the food-product in a grinding region (not shown in FIGS. 3-6) which may be defined between the stator cutter 308 and the rotating cutter 310. As such, when the food-product passes through the grinding region, the food-product, e.g. coffee beans, are cut into smaller pieces or a powder by the stator cutter 308 and the rotating cutter 310. The stator cutter 308 and the rotating cutter 310 may be of any design, for example, conical or flat disc or blade type. The rotating cutter 310 may be fixed to the bottom of the auger 306 within the feeding system 106.

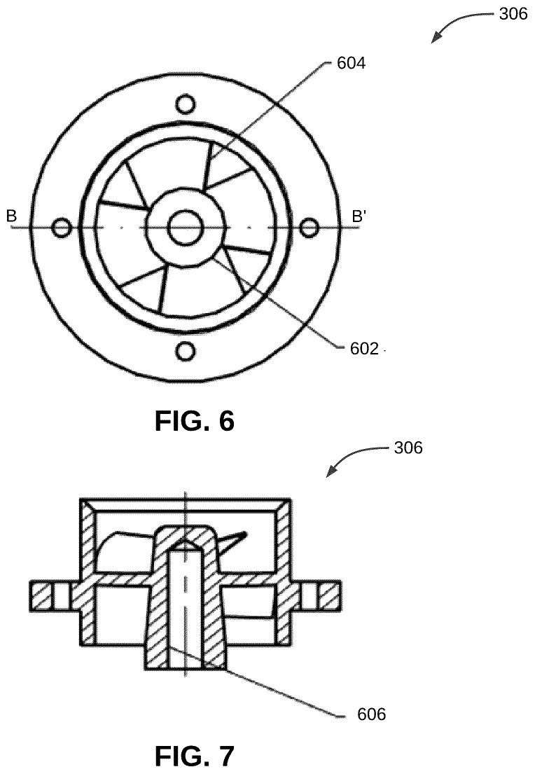

The auger 306 may be mechanically coupled to the rotating cutter 310 via a coupler 312 to cause the rotating cutter 310 to rotate about the second axis of rotation A2, to thereby grind the food product. For example, the coupler 312 may be a vertical shaft 312 (there terms “coupler” and “vertical shaft” may have been used interchangeably in his disclosure) which may be fastened with the auger 306 via a threaded hole 606 provided in the auger 306 (refer FIG. 6). In other words, both the auger 306 and the rotating cutter 310 may be mechanically coupled with the vertical shaft 312. As such, when the rotating motion is imparted to the auger 306 by the rotation source 304 (for example, via the gear assembly), the rotating motion is also imparted to the rotating cutter 310.

The coupler 312 may enable the rotating cutter 310 to be fixed to the bottom of auger 306. This arrangement allows the rotation of rotating cutter 310 when the auger 306 is rotated. At the bottom end, the coupler 312 may be supported by a nozzle 326 (refer FIG. 6). In other words, the vertical shaft 312 may be further coupled to the nozzle 326 at a bottom end of the vertical shaft 312. The nozzle 326 may direct the processed food product (e.g. ground coffee beans/powder) into a container meant for collecting or brewing coffee.

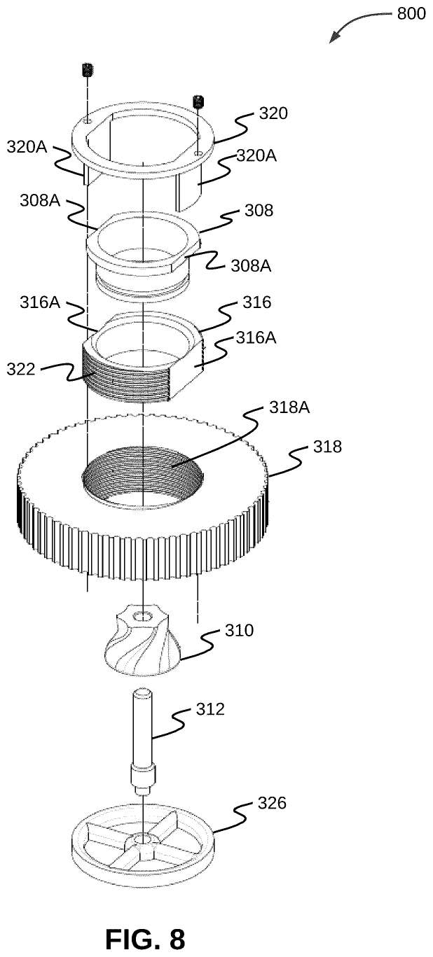

In some embodiments, the stator cutter 308 may be configured to move vertically relative to the rotating cutter 310 along the second axis of rotation A2. To this end, the food processing device 100 may further include an adjustment assembly 314. The adjustment assembly 314 may be configured to cause the stator cutter 308 to move vertically relative to the rotating cutter 310 along the second axis of rotation A2. The adjustment assembly 314 is further explained in detail in conjunction with FIG. 8.

Referring now FIG. 8, an exploded view 800 of the adjustment assembly 314 of the food processing device 100 is illustrated, in accordance with some embodiments. As shown in FIG. 8, the adjustment assembly 314 may include an adjustment sleeve 316. The stator cutter 308 may be fitted to the adjustment sleeve 316. By way of an example, the adjustment sleeve 316 may be cylindrical in shape that includes an internal cavity. The stator cutter 308 may be fixed within the internal cavity of the adjustment sleeve 316.

The adjustment sleeve 316 defines an exterior surface that may include a plurality of flat surfaces within which a guide 320 may be fitted. The guide 320, as shown in 4, supports the vertical movement of the rotating cutter 310. Further, the guide 320 includes a plurality of legs 320A, for example two legs 320A as shown in FIG. 4. The two legs 320A may engage with two faces 316A of the of adjustment sleeve 316. The two faces 316A of the adjustment sleeve 316 may be flat faces formed on the side surface of the adjustment sleeve 316. By engaging with the faces 316 of the adjustment sleeve 316, the two legs 320A prevent rotatory motion of the adjustment sleeve 316 within the adjustment ring 318.

The adjustment assembly 314 may include an adjustment ring 318 coupled to the adjustment sleeve 316 and positioned concentrically outside the adjustment sleeve 316. The adjustment sleeve 316 may fit within the adjustment ring 318. The adjustment ring 318 may include threading 318A on the inner side of the cavity. The adjustment sleeve 316 may engage with the adjustment ring 318 via the threading 318A on the inner side of the cavity. Further, as shown in FIG. 4, the stator cutter 308 may be housed within the adjustment sleeve 316. The stator cutter 308 may include flat faces 308A in its side surface. These flat faces 308A may engage with the two legs 320A of the guide 320. As such, by engaging with the flat faces 308A of the stator cutter 308, the two legs 320A prevent rotatory motion of the stator cutter 308 within the adjustment ring 318.

In some embodiments, the adjustment assembly 314 may include an adjustment lever (not shown in FIGS. 3-5) fitted to the adjustment ring 122. The adjustment ring 318 may be configured to be rotated via operation of the adjustment lever, to cause the adjustment sleeve 316 and the stator cutter 308 to move vertically relative to the rotating cutter 310 along the second axis of rotation A2.

In some embodiments, the adjustment ring 318 may be coupled to the adjustment sleeve 316 via a threaded coupling 322 (of the adjustment sleeve 316) and the threading 318A (of the adjustment ring 318). In other words, the exterior surface of the adjustment sleeve 316 may define the threaded coupling 322 which is configured to engage with threads in the internal cavity of the adjustment ring 318. The adjustment assembly 314 may be fitted at the bottom of the feeding system 106 (i.e. the auger 306). The adjustment assembly 314 is, therefore, configured to cause the adjustment sleeve 316 and the stator cutter 308 to move vertically relative to the rotating cutter 310 along the second axis of rotation A2. As mentioned above, the movement of the stator cutter 308 vertically along its axis of rotation changes the configuration of the cutter assembly 108, and allows for removal of the coffee powder from the cutter assembly 108.

As mentioned above, the rotating motion is imparted to the auger 306 by the rotation source 304 via a gear assembly 328. In some embodiments, the gear assembly 328 may include a primary gear 330 which may be coupled to the rotation source 304. The gear assembly 328 may further include a secondary gear 332 which may be fitted to the auger 306 or could be an integral part of the auger 306. The secondary gear 332 may engage with the primary gear 330 via the respective gear teeth. For example, as shown in FIG. 4, the primary gear 330 may be a spur gear which may be coupled (directly or via a planetary gear assembly as explained in the later sections of this disclosure) to the first shaft 304A of the rotation source 304. The secondary gear 332 may be another spur gear which may be fitted around the auger 306. It should be noted that the secondary gear 332 may be of a bigger size as compared to the primary gear 330. In other words, the diameter of the secondary gear 332 may be greater than the diameter of the primary gear 330, due to which the reduction of the speed for the auger 306 and a higher torque capacity of the auger 306 and the cutter assembly 108 may be achieved. It should be noted that in alternative embodiments, the secondary gear 322 may include an involute gear, a belt drive, or a bevel gear.

In some embodiments, for further reduction of the speed for the auger 306, the gear assembly 338 may include a planetary gear assembly 334. The planetary gear assembly 334 may include a set of planetary gears 334D which may be assembled between a top plate 334A and a bottom plate 334B. The planetary gear assembly 334 may further include a ring gear 334C which may be engaged with the set of planetary gears 334D via an inner side of the ring gear 334C (i.e., the set of planetary gears 334D may engage with the inner side of the ring gear 334C). The set of planetary gears 334D and the ring gear 334C may be assembled between the top plate 334A and the bottom plate 334B using a set of fasteners 334E. The set of fasteners 334E may include screws, rivets, or nut-bolt assemblies. In some embodiments, the planetary gear assembly 334 may be directly coupled with the first shaft 304A of the rotation source 304. The planetary gear assembly 334 may further coupled with the primary gear 330. The primary gear 330 may then be engaged with the secondary gear 332. By way of using the planetary gear assembly 334, a reduction of the speed of the secondary gear 332 and therefor of the auger 306 (as compared with the speed of the rotation source 304) is achieved.

Referring once again to FIG. 4, the food-product grinding assembly 400 may include the auger 306 and the cutter assembly 108. As mentioned above, the auger 306 may be configured to mechanically couple to the rotation source 304 of the food processing device 100. The rotation source 304 may be configured to generate a rotatory motion about the first axis of rotation A1. Upon coupling, the auger 306 may be configured to be rotated by the rotation source 304. The first axis of rotation A1 of the rotation source 304 may be offset from the second axis of rotation A2 of the auger 306. The auger 306 may be configured to receive a food-product from the top passage 306A and transfer the food-product towards the bottom passage 306B. the

The cutter assembly 108 may be positioned vertically below the auger 306. The cutter assembly 108 may be configured to receive the food-product from the auger via the bottom passage 306B. The cutter assembly 108 may include the stator cutter 308 and the rotating cutter 310 configured to rotate relative to the stator cutter 308. The auger 306 may be mechanically coupled to the rotating cutter 310 via the coupler 312 to cause the rotating cutter 310 to rotate about the second axis of rotation A2 to grind the food product.

The food-product grinding assembly 400 may further include the adjustment assembly 314, configured to cause the stator cutter 308 to move vertically relative to the rotating cutter 310 along the second axis of rotation A2. The adjustment assembly 314 may include the adjustment sleeve 316. The stator cutter 308 may be fitted to the adjustment sleeve 316. The adjustment assembly 314 may further include the adjustment ring 318 coupled to the adjustment sleeve 316 and positioned concentrically outside the adjustment sleeve 316. The adjustment ring 318 may be coupled to the adjustment sleeve 316 via the threaded coupling 322. The adjustment assembly 314 may optionally include the adjustment lever fitted to the adjustment ring 318. The adjustment ring 318 may be configured to be rotated via operation of the adjustment lever, to cause the adjustment sleeve 316 and the stator cutter 308 to move vertically relative to the rotating cutter 310 along the second axis of rotation A2.

The auger 306 may mechanically couple to the rotation source 304 of the food processing device 100 via a gear assembly 328. The gear assembly 328 may include the primary gear 330 fitted to the rotation source 304 and the secondary gear 332 fitted to the auger 306. The primary gear 330 may be configured to couple with the secondary gear 332 to transfer rotatory motion from the rotation source 304 to the auger 306 of the food-product grinding assembly 400. The food-product grinding assembly 400 may be configured to be retro-fitted to the food processing device 100.

Some embodiments of a food processing device and a food-product grinding assembly are disclosed. The above embodiments of the food processing device and the food-product grinding assembly are capable of pushing out all of the food product, for example coffee beans, by using a motor-driven auger. The above embodiments effectively restrict the accumulation of the powder or grinded beans in the cutter assembly, thereby allowing all of the grinded coffee beans to be flushed, thereby eliminating or reducing the need for cleaning of the apparatus. This also leads to a higher speed of operation of the device.

It is intended that the disclosure and examples be considered as exemplary only, with a true scope and spirit of disclosed embodiments being indicated by the following claims.

What is claimed is:

1. A food processing device comprising:
a rotation source generating a rotatory motion about a first axis of rotation (A1);
an auger configured to rotate about a second axis of rotation (A2), the auger being mechanically coupled to the rotation source, wherein the rotation source is configured to impart rotatory motion to the auger, wherein the first axis of rotation (A1) of the rotation source is offset from the second axis of rotation (A2) of the auger, wherein the auger is configured to receive a food-product from a top passage and transfer the food-product towards a bottom passage; and
a cutter assembly positioned vertically below the auger, the cutter assembly configured to receive the food-product from the auger via the bottom passage, wherein the cutter assembly comprises:
a stator cutter; and
a rotating cutter configured to rotate relative to the stator cutter,
wherein the auger is mechanically coupled to the rotating cutter via a coupler to cause the rotating cutter to rotate about the second axis of rotation (A2), to grind the food product.

2. The food processing device of claim 1 further comprising a hopper positioned vertically above the auger, wherein the hopper is configured to store the food-product to be grinded, and wherein the hopper is further configured to supply the food-product to the auger, via a bottom opening of the hopper and the top passage of the auger.

3. The food processing device of claim 1 further comprising an adjustment assembly, configured to cause the stator cutter to move vertically relative to the rotating cutter along the second axis of rotation (A2).

4. The food processing device of claim 3, wherein the adjustment assembly comprises:
an adjustment sleeve, wherein the stator cutter is fitted to the adjustment sleeve;
an adjustment ring coupled to the adjustment sleeve and positioned concentrically outside the adjustment sleeve; and
an adjustment lever fitted to the adjustment ring,
wherein the adjustment ring is configured to be rotated via operation of the adjustment lever, to cause the adjustment sleeve and the stator cutter to move vertically relative to the rotating cutter along the second axis of rotation (A2).

5. The food processing device of claim 4, wherein the adjustment ring is coupled to the adjustment sleeve via a threaded coupling.

6. The food processing device of claim 1, wherein the coupler is a vertical shaft,
wherein the vertical shaft is coupled to a nozzle at a bottom end of the shaft.

7. The food processing device of claim 1 further comprising a gear assembly, wherein the rotation source is configured to impart rotatory motion to the auger via the gear assembly.

8. The food processing device of claim 7, wherein the gear assembly comprises:
a primary gear coupled with the rotation source; and
a secondary gear fitted to the auger and engaged to with the primary gear.

9. The food processing device of claim 7, wherein the gear assembly further comprises a planetary gear assembly.

10. The food processing device of claim 1, wherein the hopper is positioned adjacent to the rotation source, wherein a storage area of the hopper is separated from the rotation source by a wall of the hopper.

11. The food processing device of claim 1, wherein the auger is configured to transfer the food-product in a grinding region between the stator cutter and the rotating cutter.

12. The food processing device of claim 1, wherein the rotation source is one of:
an electric motor, or
a handle configured to be operated manually.

13. A food-product grinding assembly comprising:
an auger configured to mechanically couple to a rotation source of a food processing device, wherein the rotation source is configured to generate a rotatory motion about a first axis of rotation (A1), wherein upon coupling, the auger is configured to be rotated by the rotation source, wherein the first axis of rotation (A1) of the rotation source is offset from a second axis of rotation (A2) of the auger, wherein the auger is configured to receive a food-product from a top passage and transfer the food-product towards a bottom passage; and
a cutter assembly positioned vertically below the auger, the cutter assembly configured to receive the food-product from the auger via the bottom passage, wherein the cutter assembly comprises:
a stator cutter; and
a rotating cutter configured to rotate relative to the stator cutter,
wherein the auger is mechanically coupled to the rotating cutter via a coupler to cause the rotating cutter to rotate about the second axis of rotation (A2), to grind the food product.

14. The food-product grinding assembly of claim 13 further comprising an adjustment assembly configured to cause the stator cutter to move vertically relative to the rotating cutter along the second axis of rotation (A2), wherein the adjustment assembly comprises:
an adjustment sleeve, wherein the stator cutter is fitted to the adjustment sleeve;
an adjustment ring coupled to the adjustment sleeve and positioned concentrically outside the adjustment sleeve, wherein the adjustment ring is coupled to the adjustment sleeve via a threaded coupling; and
an adjustment lever fitted to the adjustment ring,
wherein the adjustment ring is configured to be rotated via operation of the adjustment lever, to cause the adjustment sleeve and the stator cutter to move vertically relative to the rotating cutter along the second axis of rotation (A2).

15. The food-product grinding assembly of claim 13, wherein the auger is configured to mechanically couple to the rotation source of the food processing device via a gear assembly, wherein:
the gear assembly comprises a primary gear fitted to the rotation source,
the gear assembly comprises a secondary gear fitted to the auger, and
the primary gear is configured to couple with the secondary gear to transfer rotatory motion from the rotation source to the auger of the food-product grinding assembly.

16. The food-product grinding assembly of claim 13, wherein the food-product grinding assembly is configured to be retro-fitted to the food processing device.
